(19) United States
(12) Patent Application Publication
(10) Pub. No.: US 2008/0174547 A1
(43) Pub. Date: Jul. 24, 2008

(54) CONTROLLING DEVICES' BEHAVIORS VIA CHANGES IN THEIR RELATIVE LOCATIONS AND POSITIONS

(76) Inventors: DIMITRI KANEVSKY, Ossining, NY (US); ALEXANDER ZLATSIN, Yorktown Heights, NY (US)

Correspondence Address: DUKE W. YEE, YEE & ASSOCIATES, P.C., P.O. BOX 802333, DALLAS, TX, 75380, US

(21) Appl. No.: 12/056,032

(22) Filed: Mar. 26, 2008

Related U.S. Application Data
(63) Continuation of application No. 10/914,295, filed on Aug. 9, 2004.

(51) Int. Cl. G09G 5/00

(52) U.S. Cl. 345/156

(57) ABSTRACT

A mechanism is provided for allowing a user to manipulate the behavior of an electronic device by training the device to react to user-taught gestures in a certain manner. A user performs a characteristic gesture with the electronic device and/or changes the device position. When a user gesture movement is detected, a determination is then made as to whether the device behavior requested by the user movement was correctly presented to the user. If the device behavior is not correctly presented to a user, the user is allowed to train the electronic device to react to a user gesture movement by associating the user gesture movement with a particular device behavior.

### BACKGROUND OF THE INVENTION

1. Technical Field

The present invention is directed to an improved data processing system. More specifically, the present invention relates to a method, apparatus, and computer instructions for controlling the behavior of a device via learned/taught user gestures.

2. Description of Related Art

Technological advances in the computer and communication industry have resulted in improved integration capabilities. For example, integrated circuit densities are increasing which allow more functionality to be packaged into integrated circuit (IC) devices. This allows computers and other types of electronic devices to be built with fewer discreet components than previously required. Fewer components mean that the resulting product can be packaged in a smaller package. Size-reduction often allows the electronic device to become portable, as in the case of computing devices such as personal digital assistants (PDAs) and laptop computers.

Due to the demand for smaller devices, screens and keypad must either be miniaturized or repositioned to conform to the reduced device size. Consequently, proper design of the input interface of electronic devices becomes more important. Given that the space required for implementing the input interface is becoming increasingly more limited, an improper design of this interface may render the electronic device cumbersome, slow, or even unusable. It is often difficult to change the display graphics/options on small computing devices, such as a hand-held computer or a digital watch, because the devices have small displays/keyboards. Thus, it may be cumbersome and inconvenient to do any significant browsing or text editing on such small devices. For example, if a user wants to access certain information and view it on a digital watch display, the user may have to push very small buttons on the watch. In addition, too many buttons on the interface may disorient an unsophisticated user. Alternatively, too few keys on the interface may require that the available buttons be assigned secondary or even tertiary functions, greatly increasing the number of keystrokes and time required for even simple entries. A cumbersome input interface layout may render data entry slow and tedious, while tiny keys or buttons may be difficult to view and manipulate, as well as require extreme precision on the user's part.

Once common approach used to mitigate these problems in small electronic devices such as personal digital assistants (PDAs) include incorporating a scheme that allows menu and other selections to be made by touching sensitive areas of the screen. Many devices also allow alphanumeric character input by means of a stylus that is used to “write” on a touch-sensitive portion of the screen. The electronic device is then capable of translating the handwriting using a simplified handwriting-recognition algorithm. Another common approach involves utilizing user gestures to alter the content of the device display. Conventional methods of using gestures to change the display content of a device assume pre-determined movements that the user must learn and associate with device displays content changes.

### SUMMARY OF THE INVENTION

Existing interfaces that allow touch screen and stylus input, while functional, do not represent an optimal solution that adequately addresses the rapid input of alphanumeric and other data in miniaturized electronic devices. In addition, although existing devices also provide mechanisms for changing the display content of a device, none of these known devices allow a user to define a gesture and associate this user gesture with the display content of a device.

Therefore, it would be advantageous to allow a user to control the behavior of an electronic device via learned/taught user gestures. The invention allows a user to manipulate the behavior of an electronic device by training the device to react to user-taught gestures in a certain manner. A user performs a characteristic gesture with the electronic device and/or changes the device position. When a user gesture movement is detected, a determination is then made as to whether the device behavior requested by the user movement was correctly presented to the user. If the device behavior is not correctly presented to a user, the user is allowed to train the electronic device to react to a user gesture movement by associating the user gesture movement to a particular device behavior.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIGS. 1A-1D are exemplary representations of a portable electronic device in the form of a computerized/digital watch in which exemplary aspects of the invention may be implemented;

FIG. 2 is a exemplary representation of a portable electronic device in the form of laptop computer in which exemplary aspects of the invention may be implemented;

FIG. 3 is a block diagram of exemplary components used to detect and change device behaviors based on user gestures in accordance with exemplary aspects of the invention;

FIG. 4 is a block diagram of exemplary components used to teach an electronic device to react to different movements of the electronic device in accordance with exemplary aspects of the invention;

FIG. 5 is an exemplary representation of using a camera to teach an electronic device to react to different movements of the electronic device in accordance with exemplary aspects of the invention;

FIG. 6 is an exemplary representation of combining relative gestures of multiple devices to control device behaviors in accordance with exemplary aspects of the invention; and

FIG. 7 is a flowchart of an exemplary process for controlling the behavior of an electronic device via learned/taught user gestures in accordance with exemplary aspects of the invention.

### DETAILED DESCRIPTION OF THE PREFERRED EMBODIMENT

The invention allows a user to manipulate the behavior of an electronic device by providing a method to associate different types of user-taught gestures (e.g., a flick of the wrist in the case of a digital watch) with particular device responses. For example, if a user would like a digital watch to display the date, the user may flick his wrist in a certain manner. If the user would like to view the time of day, the user may flick his wrist again or perform a different special gesture and the time of day is displayed on the digital watch. In this manner, the mechanism of the invention allows a user to associate a large number of rules for changing the behavior in a way that is convenient to the user.

Gestures may include, but are not limited to, changing the location of devices, the manner in which location of the devices are changed (e.g., speed, acceleration, shaking, round/chaotic/triangle movements, etc.), and re-locating relative parts of devices (e.g., bending or tilting a laptop display). Physical actions that change the location and position of the devices include changing the form of the device, such as pressing a malleable part of the device. The device reacts to user-taught gestures by fulfilling commands directed to device behavior, such as what content to display (e.g., time or month in a watch) and/or how fast to scroll, etc. Different types of user-taught gestures may be associated with particular device reactions by classifying certain user gestures and associating them with commands, training a classification module to recognize certain class of special user gestures, teaching a device to react to different movements, or any combination of the above.

The electronic device may contain a built in system that understands specific gestures (e.g., wrist flick) to represent specific commands to display certain screens, graphics, or information in a certain way. Using a digital watch as an example, if a user flicks his wrist very strongly, the date is displayed. In contrast, if the user flicks his wrist in a circular motion, the watch will access and display the Web (e.g., stock ticker). The user may employ an unlimited variety of display options/commands that may be continually accessed via certain gestures, like the wrist flick.

Furthermore, user gesture movements may be performed using body parts that retain electronic devices. For instance, an electronic device may be retained in a user's hands, on a user's head in a headmount display, glasses, or digital hat, or on a user's legs (e.g., measuring devices). User gesture movements may also be taught by performing user gesture movements during a command/function/activity that is reproduced by other means (e.g., voice control, keyboard, interface for input, etc.). Gestures may be repeated in a different manner. User gestures may also be multimodal (e.g., combining with voice sounds or words).

In addition, the invention may be utilized in larger or normal display modalities (e.g., laptop computer). For example, if a user wants to browse through text on a display screen, rather than using a mouse or key cursor, a user may slightly tip the screen display to scroll down the page. The sharper the angle of display tilt, the quicker the text will scroll down on the screen, as though gravity is pulling the text down.

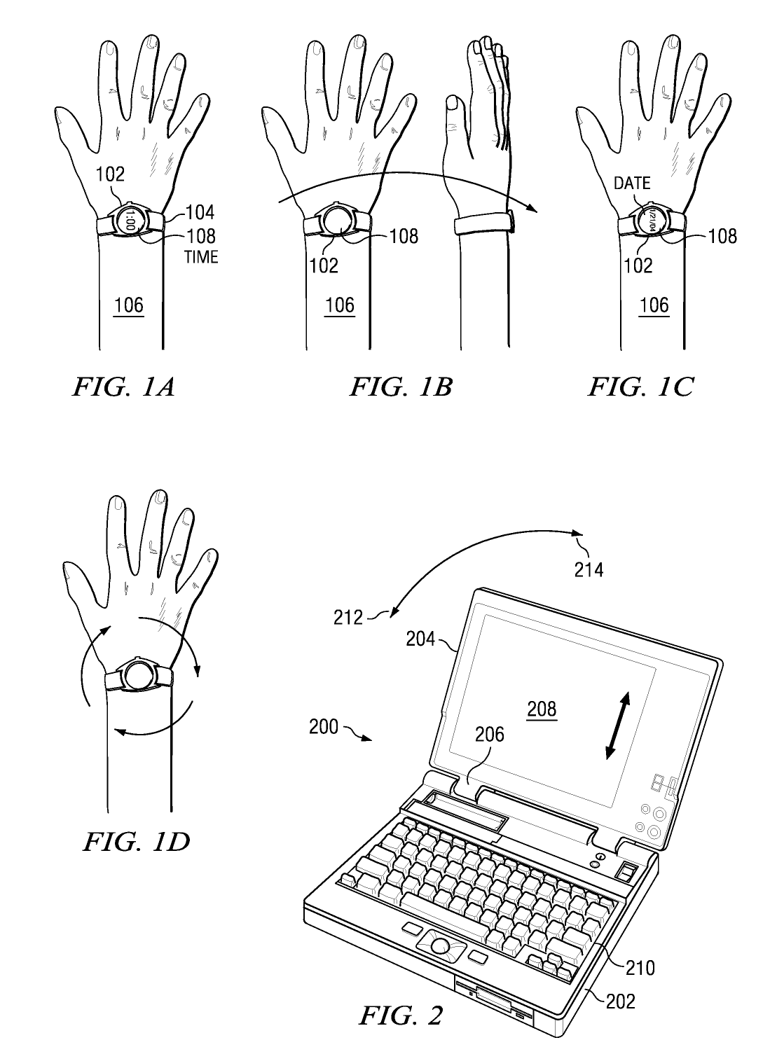

Referring now to FIGS. 1A-1D, exemplary representations of an example portable electronic device in the form of a computerized/digital watch in which exemplary aspects of the invention may be implemented are shown. However, it should be noted that the invention is applicable to many different types of portable electronic devices, such as cellular phones, personal digital assistants (PDAs), global positioning satellite (GPS) devices, digital cameras, laptop computers, headmount displays, televisions, tablets, calculators, digital pens, etc., and any combination of the above devices.

In particular, FIG. 1A provides an example illustration of an electronic watch 102 with strap 104 that passes around arm 106 of a person wearing the electronic watch. Electronic watch 102 is oriented with display 108 facing upward away from the top of the wearer's wrist in accordance with the conventional way a wristwatch is worn. When the position of electronic watch 102 and arm 106 is maintained as shown in FIG. 1A, display 108 in electronic watch 102 shows the time of day.

FIGS. 1B and 1C illustrate an example user gesture movement that may be used to change the content of display 108 and a result of that example user gesture movement. FIG. 1B shows electronic watch 102 attached to arm 106. Prior to the user gesture movement, display 108 shows the time of day as described in FIG. 1A. However, if the user moves arm 106, such as flicking the user's wrist or tilting the user's arm a certain way, display 108 in electronic watch 102 will be changed to show a different display, such as the date as depicted in FIG. 1C. Likewise, if the user moves arm 106 to yet another angle, display 108 in electronic watch 102 may show other display content, such as a stock quotation for example.

In addition, FIG. 1D illustrates possible user gesture movements a user may make to further manipulate the display content being shown by the watch. For example, when a user makes a first rotational motion with his arm, the display may show the time of day. When the user makes a second rotational motion, the display may show the month. Likewise, a third motion may show the day of the week, a fourth motion may show a stock quote, and a fifth rotation may access the Internet. These user movements may be the same rotational motion or different rotational motions, depending upon which user gestures were associated with the display content. For example, the user may teach the device to display the time of day by associating the content with a user movement in the form of a circle, and then teach the device to display the month by associating the content with a different user movement in the form of an ellipse. In contrast, a user may also teach the device to display the time of day/month/etc. by performing the same user gesture. In this particular example, the device counts the occurrences of the particular gesture and sequentially rotates the associated display content based on the count. Thus, if the user performs the same movement, the device will change the display content to the next associated display content in the sequence.

Turning now to FIG. 2, an exemplary representation of a portable electronic device in the form of laptop computer in which exemplary aspects of the invention may be implemented is shown. FIG. 2 depicts laptop computer 200 having a case or chassis 202, and upper cover 204 pivotally attached to chassis 202 along hinge 206. Upper cover 204 contains display 208, such as a liquid crystal diode (LCD) display. Laptop computer 200 may optionally contain keyboard 210. User input operations to laptop computer 200 may also be made through touch sensitive LCD display 208 using either a finger or stylus, for example.

In this illustrative example, the content of display 208 on laptop computer 200 comprises the text of an electronic book. When a user moves upper cover 204 containing display 208, the content of display 208 may change. For example, if display 208 is moved from original position 212 to new position 214, such that display 208 is now tilted at an angle, the text content shown in display 208 changes as a result of the movement (e.g., the arrow shown in display 208 indicates that by tilting the display, the user may scroll up or down the text of the book). In this manner, a user may move or tilt the display of the electronic device to scroll through the pages of an electronic book or otherwise alter the content of the display.

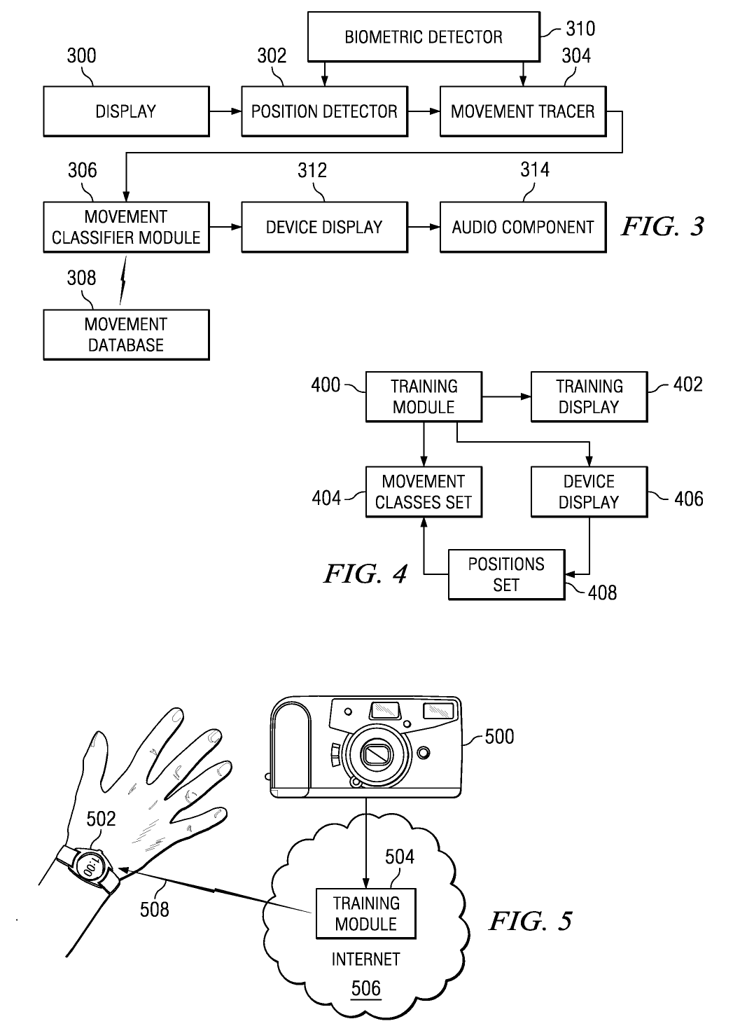

FIG. 3 illustrates an overview of an illustrative embodiment. In particular, FIG. 3 depicts a block diagram illustrating exemplary components used to detect and change device behaviors based on user gestures in accordance with exemplary aspects of the invention. The components in FIG. 3 may be implemented in an electronic device, such as electronic watch 102 in FIG. 1 and laptop computer 200 in FIG. 2, in addition to other types of portable electronic devices, such as cellular phones, personal digital assistants (PDAs), global positioning satellite (GPS) devices, digital cameras, wristwatch computers, etc., and any combination of the above.

In particular, display 300 is provided within the electronic device. Position detector 302 within the electronic device is used to detect the position of display 300. For example, position detector 302 may be a gyroscope or any known mechanism for detecting the position of the display. Position detector 302 then sends position information to movement tracer 304, which tracks the movements of the electronic device. For example, movement tracer 304 may identify the direction of the motion, whether the movement was a circular motion, a sharp flick of the wrist-type motion, or a slight tilting-type motion. Movement tracer 304 may be any known mechanism used to track the movement of the device.

Next, movement tracer 304 sends this movement information to movement classifier module 306. Movement classifier module 306 determines whether the detected movement is known and if there is a display content associated with the known detected movement. If the detected movement is known to movement classifier module 306, the movement classifier module determines if there is such an association by searching movement database 308, which is connected to movement classifier module 306 and is used to store the data received from movement tracer 304. For example, movement classifier module 306 may distinguish whether the detected movement was a circular one, a straight motion, a tilted display, a sharp flick, or a motion that was angular in three dimensional space, as well as identify a display content associated with the detected movement.

Next, movement classifier module 306 sends data to device display 312 containing a graphical user interface. If an audio component is present in the electronic device, movement classifier module 306 also sends audio data to audio component 314. Depending on the type of movement data received by movement classifier module 306, device display 312 and audio component 314 will show the associated text, specific graphical interface, and/or play the associated audio file. For example, an electronic watch may play a certain music file when the user flicks the user's wrist in a particular manner. In addition, the volume of the music file may be increased if the user flicks the user's wrist slightly harder.

Biometrics may also be used to affect the display content of the device. Biometrics are biological characteristics of a monitored individual, such as, for example, voice prints, facial bone structure, signature, face temperature infrared pattern, hand geometry, writing instrument velocity, writing instrument pressure, fingerprint, retinal print, etc., as described in U.S. Pat. No. 6,421,453, titled “APPARATUS AND METHODS FOR USER RECOGNITION EMPLOYING BEHAVIORAL PASSWORDS. Sensing devices may be used to monitor and detect a person's moods through biometric characteristics such as, for example, perspiration and heartbeat, facial expressions and head motions, and voice tones. Examples of such mood-sensing devices may be found in the following patents: U.S. Pat. No. 5,040,988, titled “VISUAL MOOD AND CAUSE INDICATOR APPARATUS AND METHOD”, which provides an apparatus with which a person can recognize his feelings or emotions and identify the cause for the person's mood; U.S. Pat. No. 5,592,144, titled “MOOD LAMP”, which provides a device with various illumination settings that can be used as a non-verbal indicator of the mood of two people; and U.S. Pat. No. 4,184,344 titled, “MOOD-INDICATING JEWELRY WITH CHANGEABLE DISPLAY”, which provides a wearable device in which a color on the device is manually selected as an indicator of the wearer's mood.

However, the present invention allows a device to react to a person's moods based on detected user gestures. Consequently, biometrics may be obtained not only from sensors, but also from how a user performs a gesture. Biometrics detector 310 is used to detect the user's moods based on a user gesture and provides this additional biometrics information to position detector 302 and movement tracer 304. Depending upon how the user performs a gesture, the user gesture/mood biometrics affect what content is displayed on the device.

For example, a user may flick the user's wrist when wearing a watch to change the display content based on the user gesture. However, depending on how strongly the user flicks the user's wrist, the device may display different content if the device determines this strong motion is evidence that the user is angry. Based on the user mood, the device may react to the user gesture by displaying certain content. In this example, if the user's mood interpreted as angry, the device may play soothing music or transmit jokes. Similarly, depending upon the movement of a person's eyes, the font on the display may be increased if the person's eyes are tired or decreased if the person is fully awake. The user may also request different display content depending on the user's moods. A user's mood may also be defined using other modalities (e.g., voice, touch sensors that detect humidity, face biometrics recognition, etc.).

A device may behave differently for different users. A user identification technique, such as the user identification technique disclosed in U.S. Pat. No. 6,421,453, may be used to identify the particular user who is using a device. This user identification technology may be implemented via gestures and contact. For instance, a husband and wife may share a device, such as a watch. When the husband performs a user gesture with the watch, such as shaking the watch, the watch displays the time of his scheduled appointment. When the wife borrows the watch, a shaking user gesture movement performed by the wife may provide a different display, such as the time of her scheduled appointment. Thus, the electronic devices may contain user profiles and behave differently for different users.

Turning now to FIG. 4, a block diagram of exemplary components used to teach an electronic device to react to different movements of the electronic device in accordance with exemplary aspects of the invention is shown. Users may specify which types of movements they would like to associate with specific commands or functions using training module 400. For example, a user may want to train the user's watch to display stock options if the user flicks the user's wrist a given number of times, or train the watch to display the date if the user slowly turns the user's wrist in a certain direction. A device may be trained in real time by the consumer. The device may also be trained in advance on the server, and then the gesture model is delivered to the end user. The training model may also be a part of the device.

Training module 400 is connected to training display 402, movement classes set 404, and device display 406. When a user wants to train an electronic device to perform a certain function based on a user gesture, training module 400 is used to observe and record the user movement. Training module 400 may employ a training technique for recognizing user gestures, such as the technique described in U.S. Pat. No. 6,421,453. Once recorded, this movement is presented to the user on training display 402 for the user's verification. As training module 400 is connected to device display 406, the result of the trained association between the user movement, the particular function, and the device positions may be presented to the user on device display 406.

Training module 400 is used to identify a particular function in movement class set 404, as well as a particular sequence of positions in position set 408 for the recorded gesture. The movement shown in training display 402 is associated with a particular function stored in movement classes set 404, and the recorded device positions due to the user gesture are stored in position set 408. In this manner, the combination of the movement classes with the position sets determines the display content shown in training display 402. Movement classes set 404 may also include audio files in addition to images.

In addition to allowing the user to train an electronic device to react to a user-taught gesture in a particular manner, the user may also be trained to perform the correct gesture in order to have a desired display content shown on the device when classes of gestures are pre-loaded in the electronic device. For example, if the electronic device does not recognize the movement the user has performed, the user may view, on the device display or another computer screen, the movement that he should be making in order to have the desired content displayed on the device. Thus, a user may be presented with the correct gestures to use to view particular device content.

Turning now to FIG. 5, an exemplary representation of using a camera to teach an electronic device to react to different movements of the electronic device in accordance with exemplary aspects of the invention is shown. FIG. 5 outlines another mechanism that may be used to track different device and user motions utilizing a camera. In this illustrative example, camera 500 monitors movements made by the user's wrist that affect the position of watch 502 worn by the user. Camera 500 sends the movement data to training module 504, which may be located in Internet 506. Training module 504 may send wireless signal 508 to the user's watch (or other computerized device) containing information regarding the recorded movement and the associated content the device should display if the movement is detected. It should be noted that like FIG. 5, FIG. 3 may also be comprised of wireless Internet capable modules for providing instruction to computerized devices.

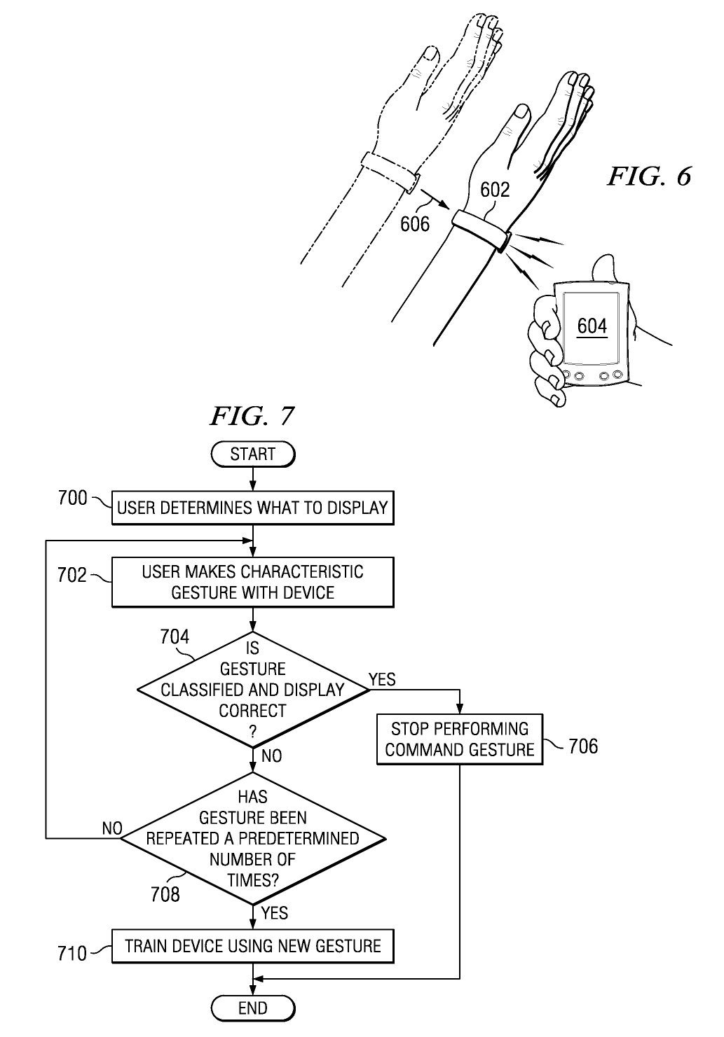

FIG. 6 is an exemplary representation of combining relative gestures with multiple devices to control device behavior in accordance with exemplary aspects of the invention. In particular, one or more user gestures may be used in combination with multiple electronic devices to affect the content of the devices. These gestures may be combined and performed relative to each other. For example, a user may be wearing watch 602 and also be carrying PDA 604. If the user makes gesture 606 with the PDA relative to the watch, such as moving the PDA towards and performing a slight tap on the watch, or vice versa, information may be transferred from the PDA to the watch, or vice versa. For instance, if the user is traveling, watch 602 may be displaying the incorrect time zone. Using combined relative gestures 606, the correct time zone information in PDA 604 may be transferred to watch 602. Similarly, as tapping a camera on a personal computer (PC) may be interpreted as an instruction to display the content of the camera on the PC, the camera may transfer information/pictures to the PC. Other user gestures may be used to transfer information between or otherwise affect the content of the devices, such as, for example, making circular movements with the camera around the PC. These relative device movements also may be interpreted as classes of gestures. The relative device movements may be trained and associated with commands by user request.

FIG. 7 is a flowchart of an exemplary process for controlling the behavior of an electronic device via learned/taught user gestures in accordance with exemplary aspects of the invention. The process begins with a user determining what behavior he wants from the electronic device (step 700). Once the user has made this determination, the user performs a characteristic gesture with the electronic device and/or changes the device position (step 702). A determination is then made as to whether behavior requested by the user gesture was correctly presented to the user (step 704). If the correct item was presented to the user, then the user stops performing the command gesture (step 706), with the process terminating thereafter.

Turning back to step 704, if the correct item was not presented to the user, a determination is made as to whether the user has attempted the gesture a predetermined number of times (step 708). If not, the process returns to step 702 and the user repeats the gesture. If the user has attempted the gesture a predetermined number of times, a training module is provided to the user so that the user may train the device to perform a particular device behavior in response to a certain user gesture (step 710), with the process terminating thereafter.

As shown in the illustrative embodiments, a user may control the behavior of an electronic device by training the device to react to user-taught gestures in a certain manner. In this manner, a user may associate a large number of rules for changing the device behavior in a way that is convenient to the user. A user may easily display or play desired content based on user gestures, as well as train a device to respond to different new user gesture movements and associate these new gestures with a display and/or audio file.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for controlling a behavior of one or more electronic devices, comprising:
detecting user gesture movements, wherein the user gesture movements are actions that change physical and space characteristics of at least part of the one or more electronic devices;
in response to detecting the user gesture movements, determining whether changes in the physical and space characteristics of the one or more electronic devices belong to a class of behaviors, where each behavior in the class of behaviors has an associated command;
in response to determining the changes belong to a class of behaviors, altering at least one behavior of the one or more electronic devices based on the associated command; and
providing a feedback to a user of the one or more electronic devices regarding the actions performed by the user.

2. The method of claim 1, further comprising:
determining whether a device behavior requested by the user gesture movements is presented to the user; and
in response to determining that the device behavior is not correctly presented to the user, allowing the user to train the one or more electronic devices to react to the user gesture movements by associating the user gesture movements with the device behavior.

3. The method of claim 2, wherein the user is allowed to train the one or more electronic devices if the device behavior is not correctly presented to a user after the user has performed the user gesture movements a predetermined number of times.

4. The method of claim 1, wherein the user gesture movements includes at least one of a shaking motion, a circular motion, a square motion, a geometric form motion, a leaning motion, a chaotic motion, an acceleration motion, and a decelerating motion.

5. The method of claim 1, wherein the user gesture movements change a form of the one or more electronic devices.

6. The method of claim 1, wherein the one or more electronic devices is at least one of a watch, personal digital assistant, telephone, headmount display, laptop computer, television, tablet, calculator, and digital pen.

7. The method of claim 1, wherein the user gestures movements are multimodal.

8. The method of claim 2, wherein the device behavior is at least one of a visual or audio content.

9. The method of claim 2, wherein the device behavior is presented to a user based on a history of the user gesture movements.

10. The method of claim 9, wherein the history is a count of the occurrences of the user gesture movements.

11. The method of claim 1, wherein the detecting step includes determining an identity of the user performing the user gesture movements to determine to which class of behaviors the user gesture movements belong.

12. A method for training a user to perform a user gesture movement to control a behavior of an electronic device, comprising:
in response to detecting a first user gesture movement unrecognizable to the electronic device;
identifying a device behavior based on the first user gesture movement, wherein the device behavior is associated with a second user gesture movement; and
training the user to perform the second user gesture movement associated with the device behavior in a manner recognizable by the electronic device.

13. A method for controlling a behavior of an electronic device, comprising:
detecting a user gesture, wherein the user gesture includes a mood biometric of a user; and
presenting the user with a device behavior based on the mood biometric.

14. A method for controlling a behavior of an electronic device, comprising:
detecting user gesture movements, wherein the user gesture movements change physical and space characteristics of at least part of a first electronic device relative to a position of a second electronic device; and
transferring a device behavior between the first electronic device and the second electronic device, wherein the device behavior transferred is based on the user gesture movements.

15. The method of claim 14, further comprising;
determining whether the device behavior associated with the user gesture movements is transferred between the first electronic device and the second electronic device; and
in response to determining that the device behavior is not transferred between the first electronic device and the second electronic device, allowing a user to train the first electronic device and the second electronic device to react to the user gesture movements by associating the user gesture movements with transferring the device behavior between first electronic device and the second electronic device.

16. The method of claim 14, wherein the first electronic device is a watch and the second electronic device is a personal digital assistant, and wherein the user gesture movements of the watch relative to the personal digital assistant transfers time data from personal digital assistant to the watch.

17. The method of claim 15, wherein the first electronic device is a camera and the second electronic device is a personal computer, and wherein the user gesture movements of the camera relative to the personal computer transfers picture data from the camera to the personal computer.

18. A data processing system for controlling a behavior of one or more electronic devices, comprising:
detecting means for detecting user gesture movements, wherein the user gesture movements are actions that change physical and space characteristics of at least part of the one or more electronic devices;
determining means for determining whether changes in the physical and space characteristics of the one or more electronic devices belong to a class of behaviors in response to detecting the user gesture movements, where each behavior in the class of behaviors has an associated command;
altering means for altering at least one behavior of the one or more electronic devices based on the associated command in response to determining the changes belong to a class of behaviors; and
providing means for providing a feedback to a user of the one or more electronic devices regarding the actions performed by the user.

19. The data processing system of claim 18, further comprising:
second determining means for determining whether a device behavior requested by the user gesture movements is presented to the user; and
allowing means for allowing the user to train the one or more electronic devices to react to the user gesture movements by associating the user gesture movements with a device behavior in response to determining that the display content is not correctly presented to the user.

20. The data processing system of claim 19, wherein the user is allowed to train the one or more electronic devices if the device behavior is not correctly presented to a user after the user has performed the user gesture movements a predetermined number of times.

21. The data processing system of claim 18, wherein the user gesture movements includes at least one of a shaking motion, a circular motion, a square motion, a geometric form motion, a leaning motion, a chaotic motion, an acceleration motion, and a decelerating motion.

22. The data processing system of claim 18, wherein the user gesture movements change a form of the one or more electronic devices.

23. The data processing system of claim 18, wherein the one or more electronic devices is at least one of a watch, personal digital assistant, telephone, headmount display, laptop computer, television, tablet, calculator, and digital pen.

24. The data processing system of claim 18, wherein the user gestures movements are multimodal.

25. The data processing system of claim 19, wherein the device behavior is at least one of a visual or audio content.

26. The data processing system of claim 19, wherein the device behavior is presented to a user based on a history of the user gesture movements.

27. The data processing system of claim 26, wherein the history is a count of the occurrences of the user gesture movements.

28. The data processing system of claim 18, wherein the detecting step includes determining an identity of the user performing the user gesture movements to determine to which class of behaviors the user gesture movements belong.

29. A computer program product in a computer readable medium for controlling the behavior of one or more electronic devices, comprising:
first instructions for detecting user gesture movements, wherein the user gesture movements are actions that change physical and space characteristics of at least part of the one or more electronic devices;
second instructions for determining whether changes in the physical and space characteristics of the one or more electronic devices belong to a class of behaviors in response to detecting the user gesture movements, where each behavior in the class of behaviors has an associated command;
third instructions for altering at least one behavior of the one or more electronic devices based on the associated command in response to determining the changes belong to a class of behaviors; and
fourth instructions for providing a feedback to a user of the one or more electronic devices regarding the actions performed by the user.

30. The computer program product of claim 29, further comprising:
fifth instructions for determining whether a device behavior requested by the user gesture movements is presented to the user; and
sixth instructions for allowing the user to train the one or more electronic devices to react to the user gesture movements by associating the user gesture movements with the device behavior in response to determining that the device behavior is not correctly presented to the user.

31. The computer program product of claim 30, wherein the user is allowed to train the one or more electronic devices if the device behavior is not correctly presented to a user after the user has performed the user gesture movements a predetermined number of times.

32. The computer program product of claim 29, wherein the user gesture movements includes at least one of a shaking motion, a circular motion, a square motion, a geometric form motion, a leaning motion, a chaotic motion, an acceleration motion, and a decelerating motion.

33. The computer program product of claim 29, wherein the user gesture movements change a form of the one or more electronic devices.

34. The computer program product of claim 29, wherein the one or more electronic devices is at least one of a watch, personal digital assistant, telephone, headmount display, laptop computer, television, tablet, calculator, and digital pen.

35. The computer program product of claim 29, wherein the user gestures movements are multimodal.

36. The computer program product of claim 30, wherein the device behavior is at least one of a visual or audio content.

37. The computer program product of claim 30, wherein the device behavior is presented to a user based on a history of the user gesture movements.

38. The computer program product of claim 37, wherein the history is a count of the occurrences of the particular user gesture movement.

39. The computer program product of claim 29, wherein the detecting step includes determining an identity of the user performing the user gesture movements to determine to which class of behaviors the user gesture movements belong.
